(19) United States
(12) Patent Application Publication
(10) Pub. No.: US 2010/0094664 A1
(43) Pub. Date: Apr. 15, 2010

(54) INSURANCE CLAIMS AND RATE EVASION FRAUD SYSTEM BASED UPON VEHICLE HISTORY

(75) Inventors: Ian Bush, Centreville, VA (US); David Lackey, Centreville, VA (US); Richard Wilson, Centreville, VA (US); David Ferrell, Centreville, VA (US)

Correspondence Address: NIXON PEABODY, LLP, 401 9TH STREET, NW, SUITE 900, WASHINGTON, DC, 20004-2128, US

(73) Assignee: CARFAX, INC., Centreville, VA (US)

(21) Appl. No.: 12/572,723

(22) Filed: Oct. 2, 2009

Related U.S. Application Data
(63) Continuation-in-part of application No. 12/105,996, filed on Apr. 18, 2008.
(60) Provisional application No. 60/907,899, filed on Apr. 20, 2007.

(51) Int. Cl. G06Q 10/00; G06Q 50/00; G06Q 40/00

(52) U.S. Cl. 705/4; 705/317

(57) ABSTRACT

A system and method of identifying warning signs of fraud associated with vehicle insurance transactions is presented. The system and method operate by identifying a vehicle, retrieving vehicle history information about the vehicle and determining if the vehicle history information indicates potential fraud based on factors which show a relationship between said vehicle history information and potential fraud incidents. Inferences related to an insurance claim or quote are made based on the results of the determination.

### CROSS REFERENCE TO RELATED DOCUMENTS

This application is a continuation-in-part of U.S. patent application Ser. No. 12/105,996, filed on Apr. 18, 2008, which claims priority to Provisional application No. 60/907,899, filed on Apr. 20, 2007, the disclosures of which are herein incorporated herein in their entirety by reference.

### FIELD OF THE INVENTION

The present invention is directed to a system and method of identifying warning signs of fraud associated with vehicle transactions. In particular, the present invention is directed to such a system and method in which potential fraud is identified based on vehicle history attributes.

### BACKGROUND

The vehicle industry is one of the largest industries in many industrialized regions of the world. As a result, the market for used vehicles, especially automobiles, has evolved into a substantial market. The vehicle insurance industry is an important part of ensuring that the risk involved in operating vehicles is distributed reasonably. However, fraud costs the industry tremendous amounts of money. Therefore, when an insurance transaction occurs, such as making a claim or receiving a quote on a vehicle, it is important to assess whether the transaction is likely to be fraudulent. Insurance companies that insure vehicles, such as auto insurance companies, often rely on an investigation of the person involved in the transaction in an attempt to identify fraud.

This type of solution is failing today because criminals are becoming more sophisticated in their processes for committing fraud, for example, through the use of computers to create fictional documents to allow for titling and registration of “paper cars” (that is, ones that do not exist but on paper), and then filing a claim for the “paper car” in question, asserting claims for damage or injury that did not occur. Personal identification tactics only work effectively when the particular person in a given transaction has a known history of detected fraud.

Within the credit industry, certain credit card transactions trigger alerts to credit card companies, which then assign investigators to contact cardholders and verify the authenticity of the transaction. However, such a transaction-based system using vehicle history has not yet been applied to vehicle insurance claims and quotes, leading to many potential advantages of using such a technique in this context to meet the unfulfilled need for an effective way to allow insurance companies to mitigate the costs of fraud.

### SUMMARY OF THE INVENTION

In accordance with an embodiment, there is a computer-implemented method of inferring potential fraud related to a vehicle insurance transaction using an electronic vehicle history database, comprising the steps of: identifying a vehicle by at least one of receiving an insurance claim on an insurance policy associated with the vehicle or receiving a request for an insurance quote on the vehicle, obtaining a VIN for the identified vehicle, using a computing device, retrieving vehicle history information about the vehicle associated with said VIN from an electronic vehicle history database, using a computing device, determining if the vehicle history information indicates potential fraud based on factors which show a relationship between said vehicle history information and potential fraud incidents related to the claim or the quote and, based on the results of said determination, flagging said incidents of potential fraud for further action.

In accordance with another embodiment, there is an apparatus designed for inferring potential fraud related to a vehicle insurance transaction using an electronic vehicle history database, comprising: means for identifying a vehicle by at least one of receiving an insurance claim on an insurance policy associated with the vehicle or receiving a request for an insurance quote on the vehicle, means for obtaining a VIN for the identified vehicle, means for using a computing device, retrieving vehicle history information about the vehicle associated with said VIN from an electronic vehicle history database, means for using a computing device, determining if the vehicle history information indicates potential fraud based on factors which show a relationship between said vehicle history information and potential fraud incidents related to the claim or the quote, and means for, based on the results of said determination, flagging said incidents of potential fraud for further action.

In accordance with another embodiment of the present invention, there is a set of instructions encoded on a computer-readable medium, which when executed by a computer carries out a computer-implemented method of inferring potential fraud related to a vehicle insurance transaction using an electronic vehicle history database, comprising instructions for carrying out the steps of the method, said instructions comprising: instructions for identifying a vehicle by at least one of receiving an insurance claim on an insurance policy associated with the vehicle or receiving a request for an insurance quote on the vehicle, instructions for obtaining a VIN for the identified vehicle, instructions for using a computing device, retrieving vehicle history information about the vehicle associated with said VIN from an electronic vehicle history database, instructions for using a computing device, determining if the vehicle history information indicates potential fraud based on factors which show a relationship between said vehicle history information and potential fraud incidents related to the claim or the quote, and instructions for, based on the results of said determination, flagging said incidents of potential fraud for further action.

### BRIEF DESCRIPTION OF THE DRAWINGS

FIG. 1 is a general schematic illustration of a vehicle history information computer system in accordance with one embodiment.

FIG. 2 is a detailed schematic illustration of the vehicle history information computer system in accordance with one embodiment.

FIG. 3 is a diagrammatic view of accumulated data for identifying a vehicle according to one embodiment.

FIGS. 4 and 5 are diagrammatic views of various data groupings according to embodiments.

FIG. 6 is a flowchart providing a general overview of an exemplary fraud detection and estimation process.

FIG. 7 is a flowchart of an exemplary fraud detection transaction.

FIG. 8 is a flowchart of fraud detection in a high mileage lease scenario.

FIG. 9 is a flowchart of fraud detection in a recently for sale flag scenario.

FIG. 10 is a flowchart of fraud detection in a stolen scenario.

FIG. 11 is a flowchart of fraud detection in a rate adjustment/non-personal ownership flag scenario.

FIG. 12 is a flowchart of fraud detection in a rate adjustment/out of area service territory scenario.

FIG. 13 is a flowchart of fraud detection in a value adjustment flags scenario.

FIG. 14 is a flowchart of fraud detection in a VIN clone flag-export scenario.

FIG. 15 is a flowchart of fraud detection in a VIN clone flag-extended inactive scenario.

FIG. 16 is a flowchart of fraud detection in a VIN clone flag-inactive scenario.

FIG. 17 is a flowchart of fraud detection in a VIN clone flag-multiple reg scenario.

### DETAILED DESCRIPTION OF THE PREFERRED EMBODIMENT

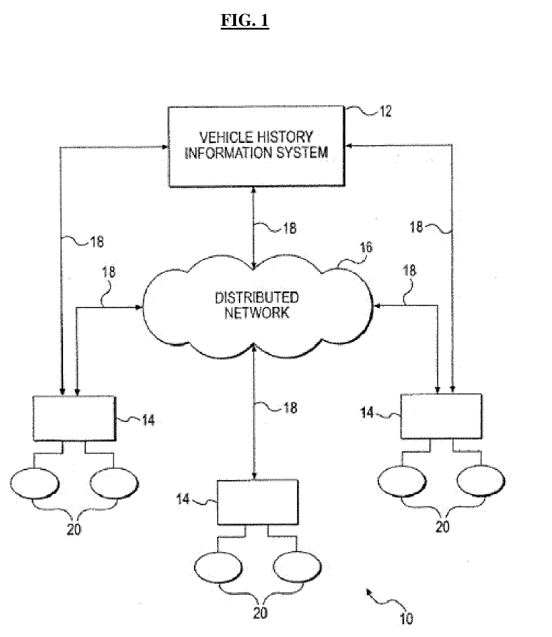

FIG. 1 is a schematic diagram of a computer system in accordance with an embodiment of the present invention that can be used to identify potential fraud. Initially, it should be understood that the term “fraud” describes in this context a current set of deceptive events associated with a vehicle transaction. The term “vehicle” is used broadly herein to encompass any sort of transportation device. For example, vehicles include automobiles of all types, motorized cycles including motorcycles and all terrain vehicles, boats, watercraft, airplanes, etc. The embodiments of the present invention may be implemented in the manner described to determine fraud likelihood for such vehicles.

FIG. 1 is a schematic diagram of a system, in the form of a networked computer system 10, designed to implement one embodiment of the subject invention. FIG. 1 may also be viewed as showing the relationship of the different entities potentially involved in the application of embodiments of the present invention. Specifically, a computer implemented vehicle history information system 12 exchanges data with one or more remote terminals 14 through data transmission across a distributed network 16, e.g. the Internet. Alternatively, the one or more remote terminals 14 may communicate directly with the vehicle history information system 12. The terminals 14 are associated with an entity (e.g., an insurance company) accessing vehicle history information system 12, as discussed more fully herein below, to obtain vehicle history information for providing assessments about fraud with respect to vehicle transactions.

The vehicle history information system 12 may be linked to one or more vehicle history data providers (not illustrated) that provide information about the events in the real world to allow the vehicle history information system administrator to receive and update vehicle history information in system 12. The vehicle history providers may be individual consumers, vehicle dealers, state titling offices, Department of Motor Vehicles, auto auctions and/or any other source of vehicle information.

The terminals 14 may be in communication with the vehicle history information system 12 via distributed network 16. The distributed network 16 may be any type of communications channel such as a local area network (LAN), wide area network (WAN), and/or direct computer connections, and can be implemented using radio frequency, infrared, or other wireless technologies using any appropriate communication hardware and protocols. Thus, terminals 14 may be connected to distributed network 16 by any communication links 18, including hardwired and/or wireless links.

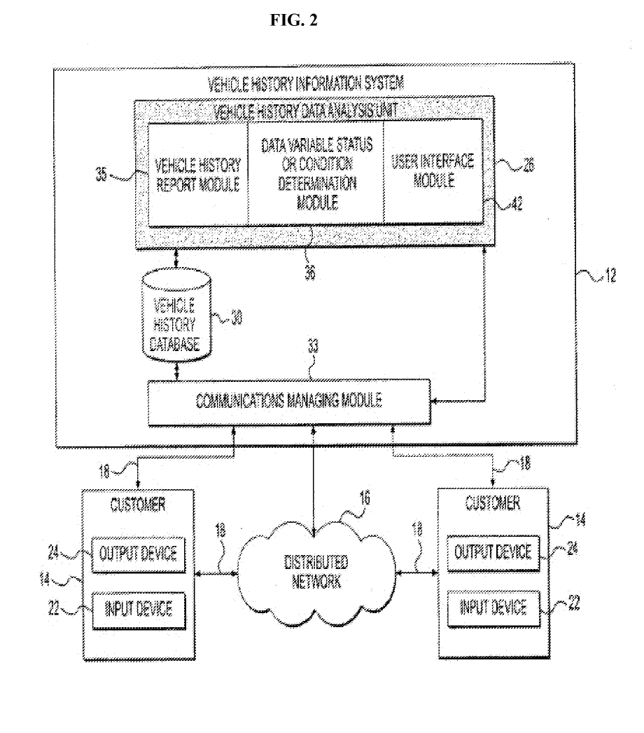

FIG. 2 illustrates in more detail the vehicle history information computer system 12 in accordance with one embodiment. Generally, vehicle history information system 12 may be implemented with any type of appropriate hardware and software, and can be embodied as computer readable storage media having executable instructions, and/or a computer architecture of computing devices as discussed herein below. Vehicle history information system 12 may be implemented using a server, a personal computer, a portable computer, a thin client, or any other computing device, such as a handset, or any combination of such devices. In this regard, vehicle history information system 12 may be a single device at a single location as shown, or multiple devices at a single location, or multiple locations that are connected together using any appropriate communication protocols over any communication medium.

FIG. 2 also illustrates in more detail the preferred implementation of the terminals 14. Although only two terminals are shown in detail as the customer terminals which represent the entities (e.g., insurance companies) of FIG. 1, it should be appreciated that any number of terminals 14 may be implemented in communication with the distributed network 16. Terminal 14 may be any appropriate computing device for accessing vehicle history information system 12 such as a personal computer, a portable computer, a thin client, a handheld device such as a mobile phone handset or PDA, and the like. Terminal 14 includes an input device 22 and an output device 24 which allow the user of the terminal 14 to provide information to, and receive information from, the vehicle history information system 12 via the distributed network 16. The input device 22 may include a keyboard, mouse, etc. as well as memory devices based on magnetic, optical and/or solid state technologies including disc drives, CD/DVD drives, flash memory, etc. The output device 24 may include a monitor screen, printer, etc. that allow the user of the terminal 14 to obtain the vehicle history information from vehicle history information system 12.

Referring again to FIG. 2, in the preferred embodiment, vehicle history information system 12 includes a vehicle history data analysis unit 26, a vehicle history database 30, and a communications managing module 33, all of which are connected together for effective data communication. Vehicle history data analysis unit 26, in the implementation shown, includes a vehicle history report module 35, a data variable status or condition determination module 36, and a user interface module 42, the functions of each being further described herein below.

The presence of fraud is determined by a data variable status or condition determination module 36, which works in conjunction with a vehicle history report module 35 and a user interface module 42 to provide an interactive analysis of the fraud situation associated with the vehicles being considered. This information is fed to the terminals 14 via the distributed network 18, and the customers interact with the vehicle history information system 2 via their terminals 12 through their input devices 22 and output devices 24.

Vehicle history database 30 contains a plurality of vehicle history datasets which are collections of vehicle history data arranged, organized, indexed and/or retrievable based on a unique indicator such as the unique vehicle identification number (such as VIN for automobiles) of a particular vehicle. Each vehicle sold within the United States and most foreign countries has a unique identification number which is identified on nearly every vehicle title issued and physically identified on the respective vehicle. The identification can be used to identify and trace the public record of each particular vehicle and to associate different vehicle data collected from a variety of sources with the particular vehicle.

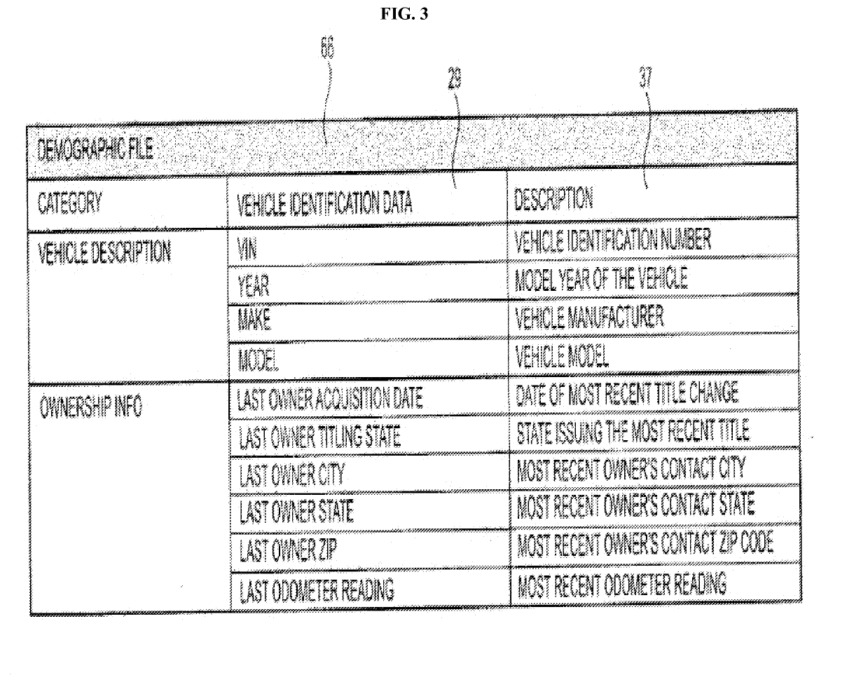

FIG. 3 shows a particular information architecture for vehicle history database 30, in which a demographic file 66 stores information about a vehicle, and vehicle identification data 29 stores a series of attributes such as VIN, year, make and model which are paired with description 37, which would be the actual value of those variables for a vehicle. An information architecture such as this allows retrieval of information about vehicles in the context of a vehicle history database 30.

It should be noted that the vehicle history information system 12 and the vehicle history data analysis unit 26 in accordance with the embodiment of the present invention is illustrated and discussed herein as having various modules which perform particular functions and interact with one another. It should be understood that these modules are merely segregated based on their function for the sake of description and do not necessarily represent discrete hardware or software code which is stored on a computer-readable medium for execution on appropriate computing hardware such as a processor. In this regard, these modules, units and other components may be hardware and/or software stored on a computer-readable medium for execution on appropriate computing hardware, such as a processor, and may be thus implemented to substantially perform their particular functions explained herein. The various functions of the different modules and units can be combined or segregated as hardware and/or software stored on a computer-readable medium as above as modules in any manner, and can be used separately or in combination.

It should be clarified that as used herein, the term “vehicle” generally refers to only one particular, physical vehicle associated with a single identification number and does not refer to general model level information or categories of vehicles. Such general model level information relating to a specific make, model and/or year, is referred to as “type” of vehicle herein. Thus, the vehicle history database 30 has a plurality of vehicle history datasets related to a plurality of vehicles, each vehicle history dataset being related to a particular vehicle and having vehicle history attributes regarding the vehicle as described below.

As previously mentioned, vehicle history information system 12 acquires vehicle history datasets from a variety of data providers. The vehicle history datasets from the vehicle history data suppliers which are entered into vehicle history database 30 are associated with a particular identification number and thus, a particular vehicle. The vehicle data forming the vehicle history datasets are added as records to vehicle history database 30 and indexed by the identification number. Therefore, the vehicle history datasets stored in the vehicle history database 30 preferably include stored vehicle history attributes for a multitude of vehicles. The vehicle history datasets may be utilized by the vehicle history information system 12 in any appropriate manner. For example, the vehicle history datasets may be utilized by the vehicle history report module 35 to generate a report by retrieving and/or calculating vehicle history attributes associated with the requested identification number of a particular vehicle. Some examples of vehicle history attributes include accident information, branded title information (such as salvage title), police accident report and damage disclosure information, mileage information (such as odometer problems and actual mileage listings), title/registration events (including government registration, taxi registration and commercial registration), stolen vehicle information, fleet information, emissions and safety inspection information, recall information, number of owners, and any other information relevant to the history of the vehicle.

Vehicle history database 30 may be any appropriately implemented database capable of effectively storing vehicle history datasets in an organized accessible manner to permit efficient easy access to desired pieces of data, e.g. one or more records associated with a particular identification number, using appropriate database management system software. Preferably, vehicle history database 30 receives information from, and may be accessed by, various components of vehicle history information system 12.

Applicants have determined that a correlation exists between certain historical attributes of a vehicle and the likelihood of fraud in an insurance transaction. Applicants' findings demonstrate that when certain events appear in a vehicle's history as vehicle history attributes in predictable ways, that indicates that fraud is more likely to occur. These vehicle history attributes from a source such as vehicle history database 30 can be analyzed to lead to conclusions about the likelihood of fraud associated with transactions involving the vehicle. They are referred to herein as “fraud likelihood data variables” 28 and are unique to each particular vehicle. This finding yields the advantageous property of embodiments which can make inferences and recommendations related to fraud related to vehicle transactions based on the vehicle history in a database such as vehicle history database 30. It is noted that the fraud likelihood data variables 28 may include, for example, only a portion of all available vehicle history attributes in database 30.

For example, an insurance company may wish to take action based upon the knowledge that a vehicle has a recorded history which incorporates certain indicators that the vehicle may likely have been involved in fraud. First, they may wish to pursue further investigation into an insurance claim to determine if a fraud is being perpetrated. Second, they may determine that it is not cost-effective to insure a vehicle having a certain vehicle history, because that vehicle's history suggests fraud which may involve concealment of insurance risks. The potential presence of fraud associated with a particular vehicle, and the necessity to take action, may be directly determined based on values of the fraud likelihood data variables 28 in vehicle history database 30. The use of the fraud likelihood data variables 28, as disclosed herein, can provide information which allows inferences about whether or not fraud has occurred, which can be useful in making decisions in insurance coverage.

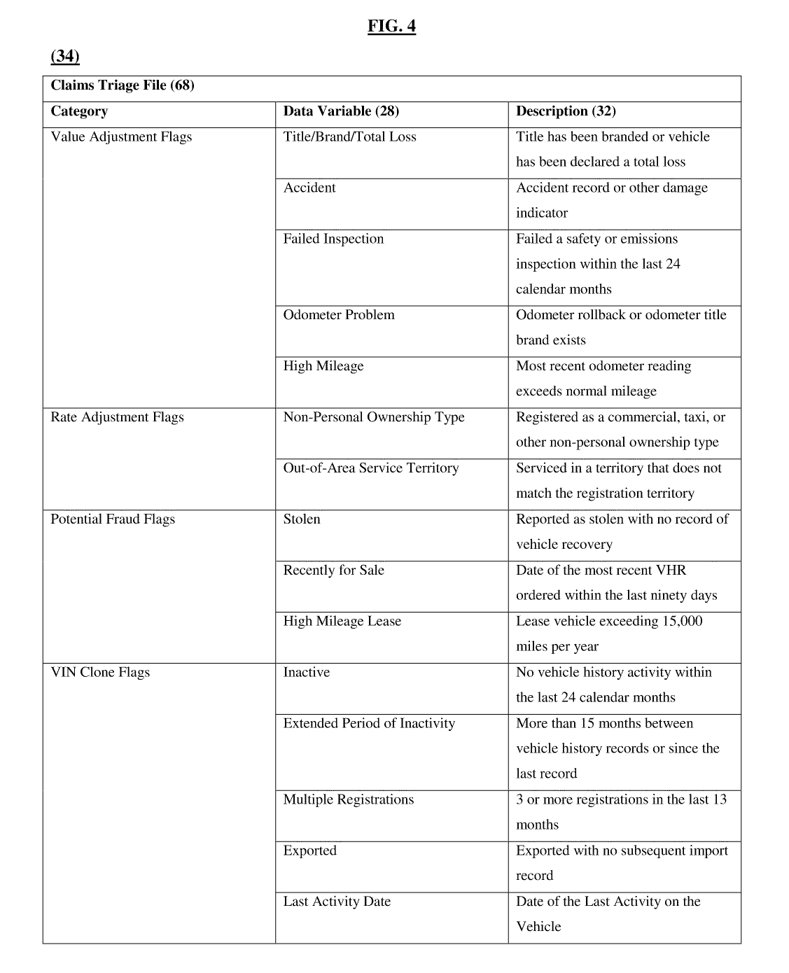

FIG. 4 shows a listing of numerous vehicle history data variables 28, discovered by Applicants to be fraud likelihood data variables 28, that may be identified and stored in the vehicle history database 30 in datasets associated with a particular vehicle. For each fraud likelihood data variable 28 listed in FIG. 4, a corresponding description 32 of that fraud likelihood data variable 28 is also provided. However, Applicants have also realized that distinct inferences can be made from evaluating fraud likelihood data variables 28 in a manner previously unknown in the prior art for determining the potential for fraud associated with insurance coverage of vehicles. These inferences further support Applicants' findings that for certain historical events of a particular vehicle, fraud is likely to occur in a present insurance transaction.

These fraud likelihood data variables 28 which Applicants have found to be relevant to the determination of fraud may be categorized and organized in several ways, as shown in FIG. 4. First, there are Value Adjustment Flags. These include several variables. The first of these is “Title Brand/Total Loss”. This variable reflects that the vehicle's title has been branded or the vehicle has been declared a total loss. The second variable is “Accident”. This variable reflects accident records or other similar damage indicators associated with a vehicle. The third value adjustment flag is “Failed Inspection”. It reflects that the vehicle failed a safety or emissions inspection within the last 24 calendar months or other relevant time period. Fourth, “Odometer Problem” reflects that odometer rollback or odometer title brand exists with regard to the vehicle's odometer. A fifth value adjustment flag is “High Mileage”, which means that the most recent odometer reading exceeds normal mileage.

Second, there are Rate Adjustment Flags. The first of these is “Non-Personal Ownership Type”. This represents that the vehicle is registered as a commercial, taxi, or other non-personal ownership type. Next, “Out-of-area Service Territory”, which means that the vehicle was serviced in a territory that does not match the registration territory.

Third, there are Potential Fraud Flags. First, “Stolen” denotes that the vehicle was reported as stolen with no record of vehicle recovery. Second, “Recently for Sale” implies that the date of the most recent VHR (Vehicle History Report) was ordered within a certain time period, such as the last ninety days. Third, “High Mileage Lease” means that the vehicle was a lease vehicle with a mileage that exceeds standard driving norms, such as more than 15,000 miles per year.

Finally, there are VIN Clone Flags. First, “Inactive” means that there has been no vehicle history activity within a certain time period, such as the last 27 calendar months. Second, “Extended Period of Inactivity” means that it has been more than 27 months, or some other relevant time period, between vehicle history records or since the last record. Third, “Multiple Registrations” means that there were 3 or more registrations in a 13 month time period. Fourth, “Exported” stands for exported with no subsequent import record. Finally “Last Activity Date” means the date of the last activity of the vehicle.

What all of these flags have in common is that they represent aspects of a vehicle's history that can be determined or inferred by processing information stored in a vehicle history information database, and which reflect a heightened chance that a vehicle with that characteristic will be the subject of insurance fraud. Based upon Applicants' research, the identification of these factors as well as the computer-based information processing system and method which exploit this property will allow valuable identification of fraudulent insurance transactions associated with vehicles.

Some of the above noted fraud likelihood data variables 28 are particularly likely to point to a likelihood of fraud in combination, while some of the fraud likelihood data variables 28 are less likely to create a suspicion of fraud in combination, depending on the selection of fraud likelihood variables 28 under consideration. For example, the likelihood of fraud associated with a vehicle insurance transaction may be increased if there is a record that the vehicle was stolen and that there were multiple registrations, because these two indicators together point to the possibility that someone may be trying to fence the vehicle. Of course, the converse may be true in that the likelihood of insurance fraud related to a vehicle may be reduced if the vehicle has a more favorable combination of factors, such as high mileage and being registered as a taxi, which would create a situation which would explain the high mileage requirement.

The fraud likelihood data variables 28 may be retrieved, processed, displayed, and/or imported/exported to other databases or forwarded to other entities. For example, the fraud likelihood data variables 28 retrieved and processed by the vehicle history report module 35 to create corresponding vehicle history reports for a particular VIN can be displayed by the user interface module 42. Thus, one embodiment of the invention includes utilizing at least one fraud likelihood data variable 28 for determining insurance transaction fraud likelihood of a vehicle. Another embodiment of the present invention includes utilizing a predetermined group of fraud likelihood data variables 28 for determining insurance transaction fraud likelihood of a vehicle as discussed more fully herein below.

Moreover, since insurance transaction fraud likelihood is relevant to risk in insurance transactions related to a vehicle, once the fraud likelihood variables have been assessed, the unique set of data variables 28 may be used to determine a premium for a particular vehicle when a rate quote is requested, or to evaluate an insurance claim. It should be noted that some fraud likelihood data variables 28 can be obtained directly from existing records, such as vehicle title records. However, some fraud likelihood data variables 28 must be derived or inferred by processing information from existing vehicle records.

Another aspect of the preferred embodiment involves the grouping together of similar fraud likelihood data variables 28 that are, for example, similar in type values. By way of example, certain fraud likelihood data variables 28 from database 30 have been selected and categorized or grouped into the data groupings 34 shown in FIG. 4. Thus, in one disclosed embodiment, selected fraud likelihood data variables 28 having common characteristics are placed within certain data groupings 34. The selection or grouping of fraud likelihood variables 28 may also take into consideration the type of fraud likelihood data variables 28 as outlined above. For example, all variables related to ownership may be grouped together. The fraud likelihood data variables can be stored separately in one embodiment in a database within a taxonomy.

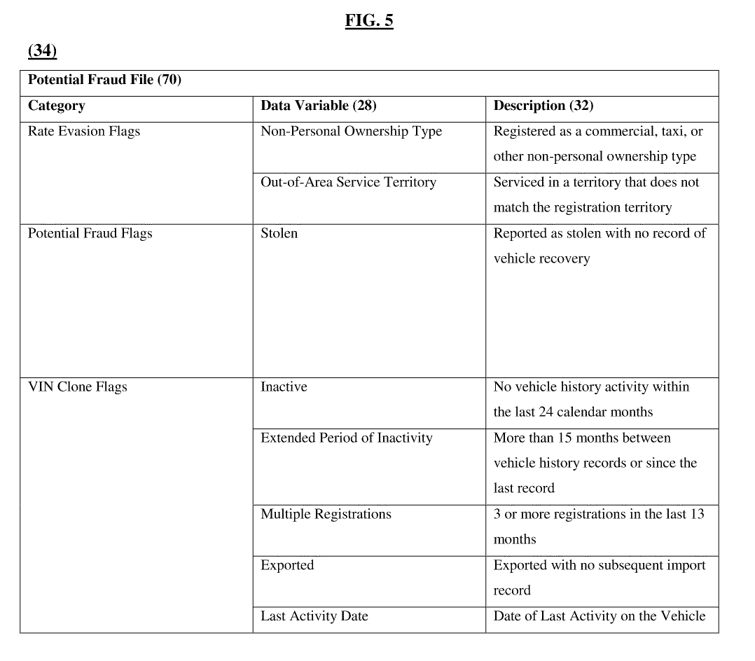

The analysis of fraud likelihood data variables 28 in the disclosed embodiment comprises at least two data groupings 34 for determining fraud likelihood as disclosed herein. As shown, for example, in FIG. 4-5, data groupings 34 of fraud likelihood data variables may be classified as a Claims Triage File 68 and a Potential Fraud File 70. The aforementioned data groupings 34 are provided as one exemplary embodiment and should not be understood to limit the scope of the invention. A Claims Triage File 68 contains a set of data variables 28 in the vehicle history whose values for a given vehicle are analyzed. Then, the history of a given vehicle 66 is compared to the Claims Triage File 68.

A Potential Fraud File 70 contains the specific fraud likelihood factors which might potentially indicate fraud with respect to that vehicle. These categories may facilitate a determination of whether fraud has occurred as disclosed herein and may also be used to make a determination about the quantitative likelihood of potential fraud, as disclosed below. In the preferred embodiment, the Potential Fraud File is a subset of the Claims Triage File, but this is not necessarily the case.

In the preferred embodiment shown, a vehicle history data analysis unit 26 includes appropriate hardware and software for implementing the vehicle history report module 35, the data determination module 36, and the user interface module 42, each module performing the functions as described in detail below. In this regard, vehicle history data analysis unit 26 may be implemented as a general purpose computing device with a central processing unit (CPU) or processor. The software for operating the vehicle history data analysis unit 26 and the various modules may reside in a computer readable storage medium in the form of executable instructions that operate the vehicle history information system 12 and perform the functions and process steps described.

In particular, the vehicle history report module 35 functions to access vehicle history database 30 to retrieve appropriate vehicle history records associated, for example, with a particular VIN that is requested by a user of the vehicle history information system 12. For example, the user can be an insurance company wishing to process a claim. Thus, the vehicle history module 35 includes the appropriate software necessary to identify the appropriate vehicle history dataset from the vehicle history database 30, and to retrieve vehicle history data based on a particular request for example, a query limited to a particular VIN or plural VINs. The vehicle history report module 35 may further be adapted to arrange and organize the vehicle history data and information in a manner appropriate for further data processing and/or display as a vehicle history report via the user interface module 42 described below.

User interface module 42 is adapted to generate a user interface or output for delivery to output device 24 of customer terminal 14. In particular, the user interface module 42 may be adapted to generate information about the likelihood of the presence of fraud in a given transaction for delivery to, and display by, output device 24 of customer terminal 14. Communications managing module 33 is adapted to manage communications and interactions between vehicle history information system 12 and its various components, as well as with the various terminals 14 via the distributed network 16.

The vehicle data determination module 36 of the vehicle history data analysis unit 26 is adapted to provide a value of one or more fraud likelihood data variables 28 as listed, for example, in FIG. 4. The values for each fraud likelihood data variable 28 are preferably indicators that the particular vehicle possesses or does not possess the characteristic of the particular fraud likelihood data variable 28, based on the real-world events in the vehicle's past that the vehicle history database 30 reflects. For example, if the vehicle history information indicates that the vehicle has or is likely to have a particular fraud likelihood data variable 28, such as that the vehicle was stolen, then the value for the “Stolen” fraud likelihood data variable 28 is a positive indication, for example, a “yes.” On the other hand, if the fraud likelihood data variable 28 does not indicate that the vehicle has or is likely to have a particular fraud likelihood data variable 28, such as not having been exported, then the value for the “Exported” fraud likelihood data variable 28 is a negative indication, for example, a “no.” Thus, for a particular fraud likelihood data variable 28, a value of the aforementioned data variable 28 is affirmed (e.g., via a “yes” indication) or denied (e.g., via a “no” indication”), and determination of the likelihood of fraud may be based on the affirmation or denial of the value of the fraud likelihood data variable 28. Such a determination may lead to further investigation or changes in an insurance quote or claims adjustments.

In other instances, the resulting information provided by evaluating a fraud likelihood variable 28 may not necessarily provide an indicator such as a positive or negative indicator, for example “yes” or “no,” respectively. For example, the “Recently For Sale” 72 allows one to assess a date indicating the approximate time period when a vehicle was offered for sale. In this example, the aforementioned data variables 28 are associated with a date which may be evaluated and/or analyzed against other dates. For example, the question may be whether the value of the data variable 28 exceeds a threshold value or falls within a particular date range or proximity to other dates, such as the date a claim was made.

In keeping with their descriptions, factors such as “Last Activity Date” may indicate heightened risk of insurance transaction fraud as the factor that they indicate becomes increasingly disparate from the norm. Thus, for example, fraud is more likely to have occurred for vehicles where the last activity date is more than 5 years previous relative to vehicles where the last activity date is only 1 year previous. In embodiments of the current invention, a fraud likelihood variable 28 which may be associated with a spectrum of circumstances may be analyzed by an embodiment of the present invention so that a moderate risk of fraud is indicated when a marginal value of the fraud likelihood variable occurs and a heightened risk of fraud is indicated when a sharply disparate value of the fraud likelihood variable is present.

For certain data groupings 34, the vehicle data determination module 36 of the vehicle history data analysis unit 26 may be adapted to provide an overall value of an entire data groupings 34. That is, if any one fraud example data variable 28 of a particular data grouping 34 has a positive indication, for example, a “yes,” then the overall value of the data grouping 34 is also positive or “yes.” However, it is noted that Boolean variables, true/false, 0/1, scales, or any other formulation of the variable that reflects the data grouping that can indicate when a fraud is more or less likely to have occurred can be used. For example, in reviewing the Potential Fraud File 70 of FIG. 5, the flags are grouped into three subgroupings, “Rate Evasion Flags”, “Potential Fraud Flags”, and “VIN Clone Flags”. Within these subgroups, if any of the individual fraud likelihood variables 28 indicates a cause for potential suspicion that fraud may be present, it indicates the subgrouping should be characterized to indicate that fraud may be present. Thresholds may be set so that several fraud likelihood variables 28 within a subgrouping or several concurrent subgroupings must raise cause for alarm before the system or method flags a problem. Thus, in this example, if the overall value is “yes,” then the determination is made that there is significant chance of fraud, and it may be necessary to investigate an insurance quote or claim accordingly. Alternatively, if the overall value is “no,” then the determination is made that the vehicle history does not indicate any enhanced likelihood of fraud, in which case events can proceed as they would have without investigation. Thus, determination of whether there is a potential for insurance transaction fraud is based on some combination of respective overall values of the data groupings 34. For example, if the majority or all of the overall values of the data groupings 34 are in the affirmative, e.g., “yes,” or negative, e.g., “no,” then that determination and appropriate attendant subsequent action should be appropriately made based on this result. Note that as an alternative, the user may specify how the fraud likelihood variables 28 are to be grouped into the data groupings 34.

Thus, the information, i.e., overall value provided by an analysis of the fraud likelihood data groupings 34, can facilitate a determination of vehicle insurance transaction fraud likelihood as disclosed herein. This, at least, is due to the correlation of the likelihood data variables 28 listed in the data grouping 34 in various combinations, with an empirical incidence of fraud associated with vehicles possessing those variables in their histories. The thusly formed data groupings 34, created in accordance with the disclosed embodiments of the invention, can provide information previously unknown in the art for determining fraud likelihood, since the data grouping 34 is specifically packaged to provide specific vehicle history information regarding fraud which can indicate when further investigation into a vehicle insurance transaction is warranted.

While the disclosure describes use of the data groupings 34 comprised of fraud likelihood data variables 28, it is noted that the fraud likelihood data variables 28 have separate utility apart from being grouped into the aforementioned data groupings 34. The value of the fraud likelihood data variables 28 can be reviewed, for example, by an insurance company (or other entity), and used as a basis for initiating fraud investigations, adjusting claims, and setting rate quotes, at a minimum, as described herein. This may include a scenario in which the value of one fraud likelihood data variable 28 is evaluated and a decision to start an investigation, adjust a claim, or adjust a rate quote occurs based on this value. In another scenario, the values of a plurality of fraud likelihood data variables 28, whether similar or not, may be evaluated and underwriting and rating occurs based upon the results, e.g., any one value exists, a majority of the values exist, or a combination of the values exist or do not exist.

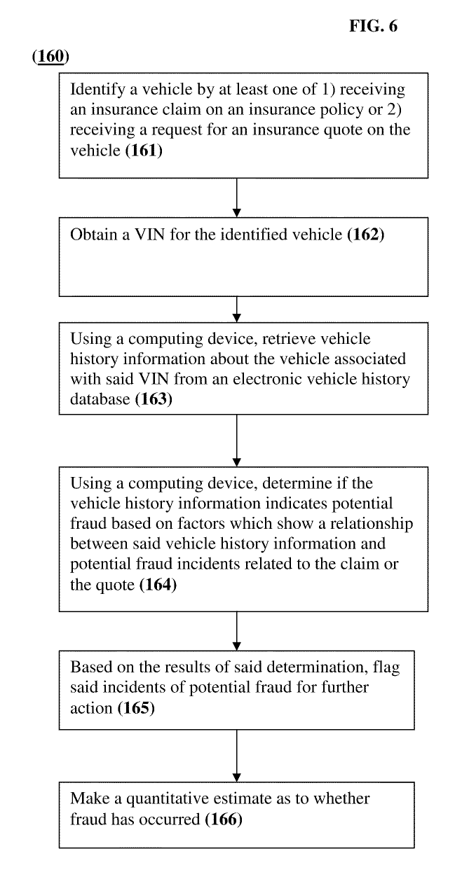

Thus, as shown in FIG. 6, a computer-implemented method which an exemplary embodiment of the invention executes involves first, to identify a vehicle by at least one of 1) receiving an insurance claim on an insurance policy or 2) receiving a request for an insurance quote on the vehicle (step 161). This identifying step may be done either automatically in accordance with predefined rules and/or procedures or by involving a selection by the user. The next step is to obtain a VIN for the identified vehicle (step 162). Third, the method calls for using a computing device, retrieving vehicle history information from an electronic vehicle history database about the vehicle associated with said VIN (step 163). Fourth, the method involves using a computing device, determining if the vehicle history information indicates potential fraud based on factors which show a relationship between said vehicle history information and potential fraud incidents related to the claim or the quote (step 164). Finally, the method calls for, based on the results of said determination, flagging said incidents of potential fraud for further action (step 165).

Thus, in FIG. 6, the VINS identify vehicles (steps 161-162) which allows the method to associate fraud likelihood data variables 28 (step 163) with the one or more submitted VINS. Each fraud likelihood data variable 28 will indicate a warning to the insurance company based on whether the vehicle history record for that particular vehicle possesses or does not possess the characteristic of the particular fraud likelihood data variable 28. However, the system and method may also record additional information related to the fraud likelihood variable 28. For example, if there has been an “Extended Period of Inactivity” (More than 27 months between vehicle history records or since the last record), the system and method may also store, for example, the specific period of inactivity. The fraud likelihood data variables 28 may further be combined into pre-selected data groupings 34 as previously discussed. Based upon a value of the respective fraud likelihood data variables 28 or the overall value of the respective data groupings 34, determination of whether fraud is likely (step 165) occurs based on the values of the fraud likelihood data variables 28 or the overall values of the one or more data groupings 34. Furthermore, if the determination is made that fraud is likely, a quantitative estimate of the likelihood that fraud has occurred may be made (step 166) based upon information associated with the fraud likelihood data variables 28, such as the value of one or more variables, the overall value of one or more groups of variables, or a value of a score based on one or more data variables as discussed herein below. In another embodiment, the information associated with the fraud likelihood data variables 28 may be used only for providing an estimate of the likelihood that fraud has occurred.

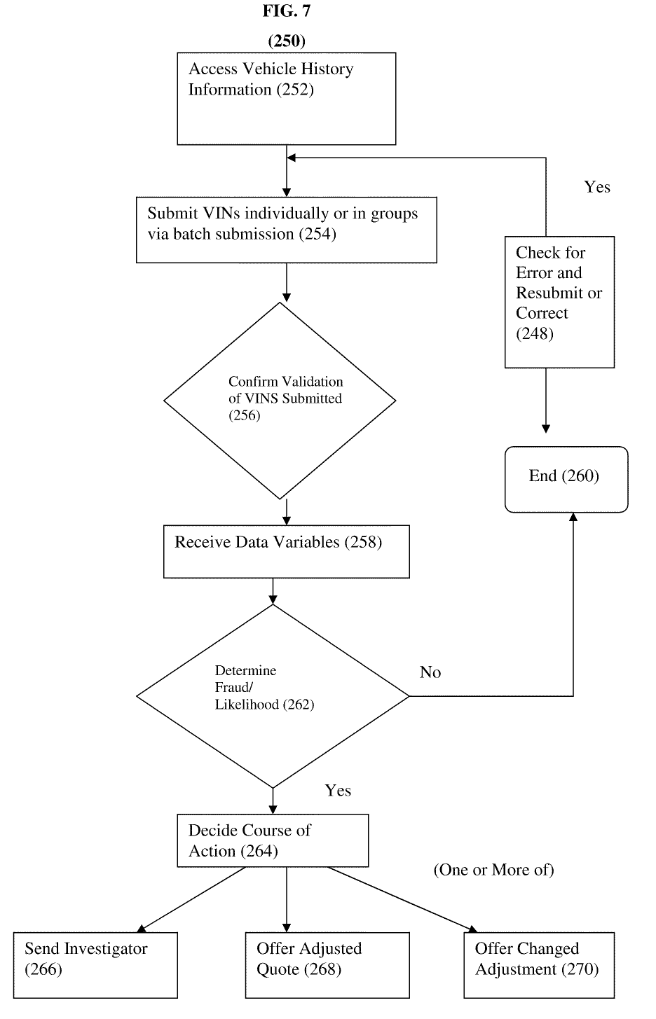

Turning to FIG. 7, an example of how determination of an insurance transaction fraud potential based on vehicle history works is illustrated. An insurance company (or another individual or entity who has reason to want to know about potential fraud associated with a vehicle insurance transaction) may be granted access to the vehicle history information (step 252) provided, for example, by a vehicle history provider. Note that the embodiments operate when a potential transaction is under consideration as to whether fraudulent elements are involved. In one embodiment, the vehicle history provider maintains the vehicle history information system 12 (FIGS. 1 and 2) and is capable of providing data variables 28, and/or grouping data variables 28 to create data groupings 34, according to preferences of the insurance company or other user. The user determines and requests which data groupings 34 will be provided from the vehicle history provider for an agreed transaction price. In one example, the aforementioned transaction price may be based upon a number of VIN numbers submitted to the vehicle history provider by the user.

Thus, the insurance company submits the VINS (step 254), for example, individually or in a batch submission, to the vehicle history provider. The vehicle history provider may have an established distributed network 16 (FIGS. 1 and 2) in place to receive and forward the VINS submitted by the insurance company to the vehicle history information system 12 (FIGS. 1 and 2). Alternatively, vehicle history provider may allow the insurance company to submit the VINS directly to the vehicle history information system 12.

The VINS are validated (step 256) and the process continues. In one embodiment, the validation process may include receiving information to confirm the vehicle of interest. For example, FIG. 3 depicts a “Demographic File” 66 which provides an exemplary array of information or vehicle identification data 29. The Demographic File 66 may be helpful in confirming that the requested information for the submitted one or more VINS is indeed attributed to the correct one or more vehicles. Thus, the description 37 of each vehicle identification data 29 may further facilitate confirmation of one or more preferred vehicles. In an instance wherein the VINS are not confirmed, the VINS may be checked for accuracy and resubmitted for processing (step 248). Alternatively, the process may end (step 260).

Upon confirmation of the VINS (step 256), fraud likelihood data variables 28 are collected from a larger set of vehicle attributes in vehicle database 30 associated with each vehicle and forwarded to the vehicle history data analysis unit 26 (step 258). In the present example, the fraud likelihood data variables 28 are gathered into the data groupings 34. Upon receiving the data variables 28 and data groupings 34, the vehicle history data analysis unit 26 proceeds with the analysis of the information, which involves determining relationships between the various parts of the data to provide a unified indication as to whether fraud has occurred or not and/or a probability about whether fraud has occurred (step 262). The insurance company may then use this recommendation associated with the received data variable 28 and data grouping 34 information to choose a course of action (step 264). For example, the action may include sending an investigator to investigate fraud (step 266) or offering an adjusted quote (step 268) or changed adjustment (step 270).

In a particular embodiment, an analysis of fraud likelihood data variables 28 selected, for example, from the vehicle history database 30 may be performed in which the fraud likelihood data variables 28 are utilized to generate a scoring result, i.e., a score. Thus, the score may be used to assess how likely fraud is to occur. Importantly, the score may also facilitate using the results of the fraud likelihood analysis to determine an insurance price or premium. The score may include a numerical value, for example, indicative of a value for an insurance price or premium for a potential customer. However, the score may also be expressed in any other form which permits the indication of whether fraud is likely to have occurred. That is, the score may be used to generate an overall fraud likelihood attributed to an assessment of risk for a prospective insurance consumer or anyone else who might stand to benefit from having knowledge about [past] potential? fraud associated with a vehicle. The decisions about how to handle the actions taken based on the fraud likelihood processing and the scoring process itself may be based on the same integrated criteria or rules or may be based on separate criteria or rules.

Thus, in one example, the insurance company supplies one or more VINS to the vehicle history provider. Fraud likelihood data variables 28 are generated, for example, in accordance with a predetermined agreement. One or more of the fraud likelihood data variables 28 may be processed and transformed into an output. The output may be characterized as a score, which may include a numerical value, mark, symbol, color, and/or any other suitable representation for generating an output. Hence, in one embodiment, the score may include a single numerical value indicative of a result of the data variables 28 being fed within and processed by the algorithm. Furthermore, each of the respective data variables 28 fed to the algorithm may be suitably weighted according to a user preference, which may be guided by empirical knowledge about the importance of various factors or by other motivations. Thus, in one embodiment, certain fraud likelihood data variables 28 may be weighted more than others, because a user may be interested in particular trends or characteristics of some data variables 28 more than others. For example, an entity such as an insurance company or user, may prefer that certain fraud likelihood data variables 28 have a greater impact on determining whether fraud has occurred than other fraud likelihood data variables 28. An example of this would be that an insurance company or user might want to emphasize odometer-related data, because they have information related to that particular vehicle or class of vehicles that such data would be particularly helpful. Therefore, in this embodiment, fraud likelihood analysis, that is, determining whether there is an enhanced likelihood of fraud and/or how enhanced that likelihood is, is not based on any one value or any one overall value but a weighted combination, i.e., algorithmic or mathematical model or equation.

The transformation algorithm may be embodied in a software program appropriately configured to run the algorithm on a computer and produce the output described hereinabove. In the preferred embodiment, said software program will run as a series of modules executed on appropriate computing hardware, or alternatively may consist of a set of computer-readable media with instructions which when executed by a processor implement the functions. The algorithm may be adaptable for receiving inputted data such as the fraud likelihood data variables 28. Thus, in one embodiment, data, such as fraud likelihood data variables 28, may be inputted via the software program into the algorithm whereupon the software program executes the algorithm to produce an output such as the disclosed score. In operation, an entity, such as the vehicle history provider, may provide a service to a client, such as an insurance company. The service may include running the algorithm and providing a score to the insurance company. Alternatively, the algorithm may be run directly by a party desiring an output of the algorithm (e.g., the score as disclosed herein).

Hence, in accordance with one embodiment, an algorithm may be provided as follows:

[X]A+[Y]B . . . +[Z]C=SCORE

wherein X, Y, and Z are weight factors and A, B, and C are data variables 28 selected from the vehicle history database 30. Thus, in one exemplary application, the following formula based on the disclosed algorithm model is provided as:

(A*125)+(B*50)+(C*20)=SCORE

where A is the value of the stolen data variable, B is the value of the high mileage data variable, and C is the value of the last activity date data variable; and wherein,
If the vehicle was reported as stolen with no record of vehicle recovery, then A=1.
If the vehicle was not reported as stolen with no record of vehicle recovery, then A=0.
If the vehicle is a lease vehicle with high mileage, then B=1.
If the vehicle is not a lease vehicle or does not have high mileage, then B=0.
If the last activity date is past a certain threshold, for example 12 months, then C=1.
If the last activity date is not past a certain threshold, for example 12 months, then C=0.

In this example, the value of fraud likelihood data variable A, directed to whether the car was stolen, is weighted more heavily than the value of fraud likelihood data variables B and C, directed to high mileage and last activity, respectively Likewise, the value of fraud likelihood data variable B is weighted more heavily than the value of fraud likelihood data variable C. The higher weighted fraud likelihood data variable is, therefore, given a higher impact on the fraud likelihood score than a lower weighted fraud likelihood data variable. Of course, in an embodiment using data groupings 34, A, B, and C (in the above example) may represent overall values of data groupings 34.

Note further that an embodiment is possible where an algorithm is used where A, B, and C (or whichever variables are used) assume values other than 1 and 0. For example, the variable may take on the value of the specific number of months or years since the vehicle's last activity date, to reflect the amount of deviation from normal behavior that would be indicative of fraud. A scaling formula may be used to combine information related to such a variable and incorporate it into the algorithm.

In the previous example, the score is represented as a numerical value. Thus, a decision to investigate further, to modify an insurance quote, or to make a claims adjustment may rely on whether the score falls into a numerical range. For example, if the available scoring range is from 0-100, then it may be determined that scores from 70-100 indicate that a further investigation is warranted and thus a score below 70 will indicate that no further investigation is warranted. Similarly, a score above 70 may indicate that a quote or adjustment with an enhanced cost to the owner of the vehicle will be employed by the insurance company. Importantly, furthermore, the same numerical result of the score may be utilized to determine calculations related to insurance transactions related to the vehicle in order to set a price or premium. For example, if the score falls in a range of 70-80, then the price or premium is set at a first dollar amount. Similarly, if the score falls in a range of 80-90, then the price or premium is set at a second dollar amount different than the first dollar amount. Likewise, if the score falls in a range of 90-100, then the price or premium is set at a third dollar amount different than the first and second dollar amounts. Alternatively, the rating procedure can be based on a separate algorithm or rule and/or a separate score, with respect to the underwriting procedures.

As discussed above, the output, i.e., score, of the algorithm may be useful in a variety of applications for assessing risk of fraud. For example, if the score is represented as a color, such as green, or a mark such as “+”, or a word such as “go”, then the indication of green, or “+” or “go” may mean that it is advisable to proceed without further investigation, or that it is advisable to provide a favorable insurance quote or claims adjustment. Alternatively, if the score is represented as a color, such as red, or a mark such as “−”, or a word such as “stop”, then the indication of red, or “−”, or “stop” may mean that further investigation is advisable, or that it is necessary to modify the insurance quote or claims adjustment adversely. Alternatively, an insurance company may decide to go so far as to withhold insurance coverage altogether if a negative indication occurs.

Also, the score may be used to determine an insurance price or premium. Such determination may be proportional to the score. For example, having calculated a score in accordance with the algorithm above, wherein the score is a numerical value, a calculated insurance premium (IP) may be determined as follows:

IP=P*SCORE/K

wherein P is a computed insurance price or premium based upon non-vehicle history data variables and K is a scaling factor appropriate to the range of scores. The variable “P” may be based upon criteria utilized in typical calculations for determining an insurance price or premium, such as the driving record or history of the particular person/driver listed on the policy. Thus, the value “IP”, according to the disclosed embodiment, provides a modified or “new” price value which otherwise generates an updated insurance price or premium based upon the disclosed score.

Hence, a practical embodiment of the use of the algorithm incorporating fraud likelihood data variables 28 has been shown. It has been further shown that the fraud likelihood data variables 28 may also be manipulated, such as being weighted against one or more fraud likelihood data variables 28 within the algorithm, in order to affect fraud likelihood as deemed appropriate.

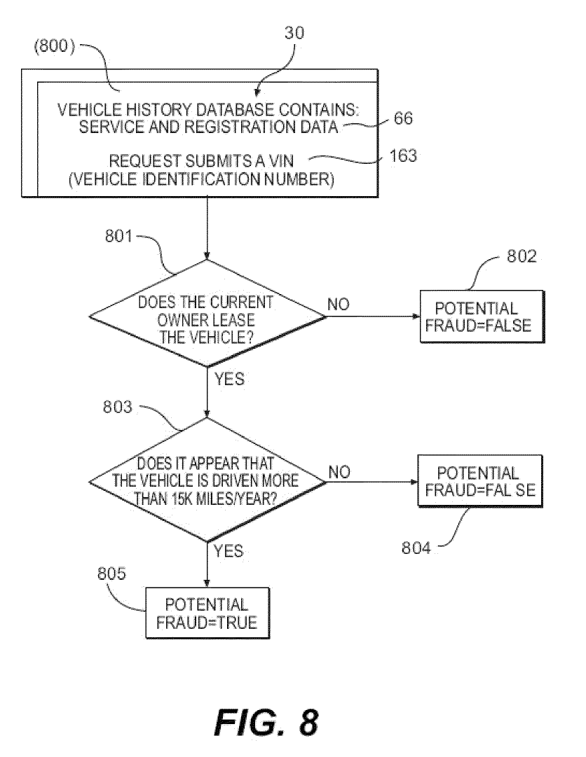

FIG. 8-17 illustrate ten specific decision processes by which the determining step 164 may be implemented. These are illustrative examples, and should serve to show how versatile the principles developed in these embodiments in fact are without placing any undue constraints on the scope of the claims. The “answers” to the “questions” in the examples are determined by programmed logic in the vehicle information system 12 examining data in records of vehicle history database 30.

### Example I

### FIG. 8

In FIG. 8, at 800, the background of the determining step 164 is that the vehicle history database 30 contains service and registration data, and the request submits a VIN# 163. The logic of the embodiments proceeds through a decision process, asking “Does the current owner lease the vehicle?” 801. If no, then potential fraud=false 802. However, if yes, then it is asked, “Does it appear that the vehicle is driven more than 15K miles/year 803. If no, then potential fraud=false 804. However, if yes, then potential fraud=true 805. This is based on the assumption information comes from a provider such as CARFAX™ that maintains an ownership database based upon public and private sources, and that the provider such as CARFAX™ employs a number of calculations to determine the annual mileage that a vehicle was driven over a yearly period.

Thus, the determining step here comprises determining if there is an indication that a vehicle is leased and a history that the vehicle is driven more than 15,000 miles per year. If both are true, i.e. yes, then the determining step determines that there is potential fraud.

### Example II

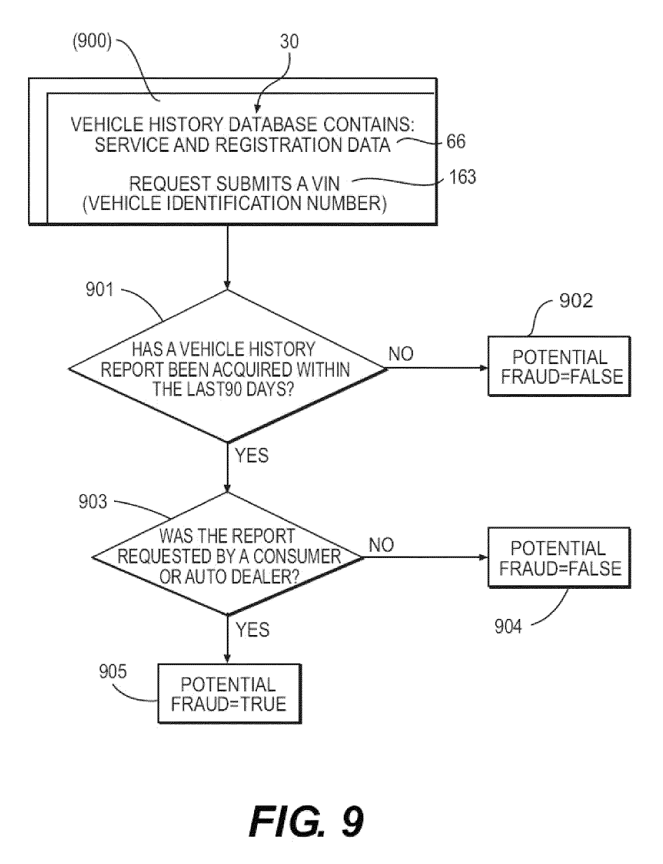

### FIG. 9

In FIG. 9, at 900, the background of the determining step 164 is that the vehicle history database 30 contains service and registration data, and the request submits a VIN# 163. The logic of the embodiments proceeds through a decision process, asking “Has a vehicle history report been acquired within the last 90 days?” 901. If no, then potential fraud=false 902. However, if yes, then it is asked, “Was the report requested by a consumer or auto dealer 903. If no, then potential fraud=false 904. However, if yes, then potential fraud=true 905. This is based on the assumption the vehicle history provider, such as CARFAX™, stores requests for Vehicle History as a standard business practice for billing purposes. This usage is compared to the requested vehicle identification number (VIN) to determine if the VIN has been requested in the past ninety days.

Thus, the determining step here comprises determining if there is an indication that a vehicle history report has been acquired within the last 90 days and a history that the report was requested by a consumer or auto dealer. If both are true, i.e. yes, then the determining step determines that there is potential fraud.

### Example III

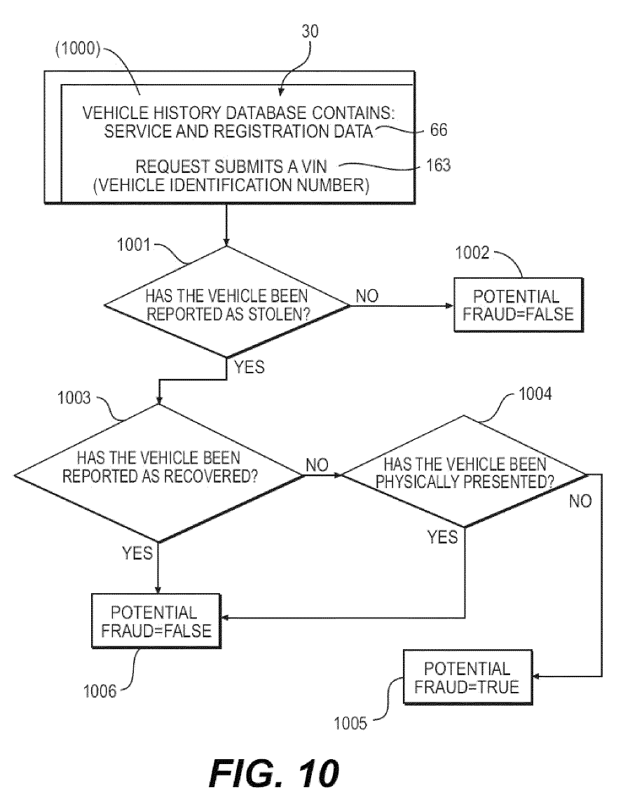

### FIG. 10

In FIG. 10, at 1000, the background of the determining step 164 is that the vehicle history database 30 contains service and registration data, and the request submits a VIN 163. The logic of the embodiments proceeds through a decision process, asking “Has the vehicle been reported as stolen?” 1001. If no, then potential fraud=false 1002. However, if yes, then it is asked, “Has the vehicle been reported as a recovered by a vehicle history source?” 1003. If yes then potential fraud=false 1006. However, if no, then it is asked if the vehicle has been physically presented? 1004″. If yes then potential fraud=false 1006. If no then potential fraud=true 1005. This is based on the assumption the vehicle history provider, such as CARFAX™stores stolen records from a large number of police and private sources. In this context, physically presented indicates that the vehicle history provider has received a record that the vehicle has been verified as not stolen by a reputable source.

Thus, the determining step here comprises determining if there is an indication that a vehicle was stolen, that it was not reported as recovered by an authoritative vehicle history source, and that the vehicle was not physically presented. Thus, if stolen is yes, physically presented is no, and recovered is no, then the determining step determines that there is potential fraud.

### Example IV

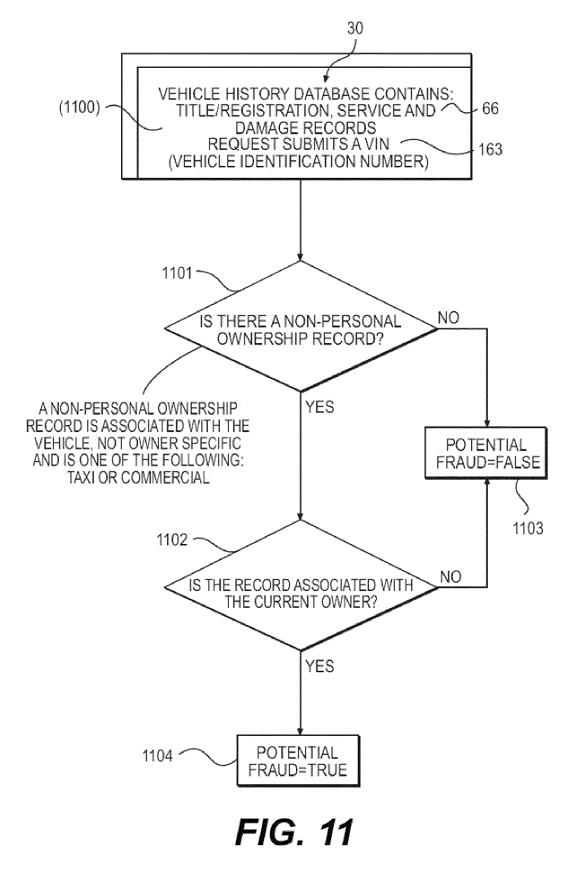

### FIG. 11

In FIG. 11, at 1100, the background of the determining step 164 is that the vehicle history database 30 contains title/registration, service and damage data, and the request submits a VIN# 163. The logic of the embodiments proceeds through a decision process, asking “Is there a non-personal ownership record?” 1101. If no, then potential fraud=false 1103. However, if yes, then it is asked, “Is the record associated with the current owner 1102. If no, then potential fraud=false 1103. However, if yes, then potential fraud=true 1104. In this context a non-personal ownership record indicates that a vehicle is used for uses other than personal use (e.g., Taxi or Commercial). Here a taxi is defined as a vehicle primarily used to convey passengers for a fee, and not for personal use, and a commercial vehicle is a vehicle used for commercial purposes, such as a limousine, or hauling truck.

Thus, the determining step here comprises determining if there is an indication that there is a non-personal ownership record and the record is associated with the current owner. If both are true, i.e. yes, then the determining step determines that there is potential fraud.

### Example V

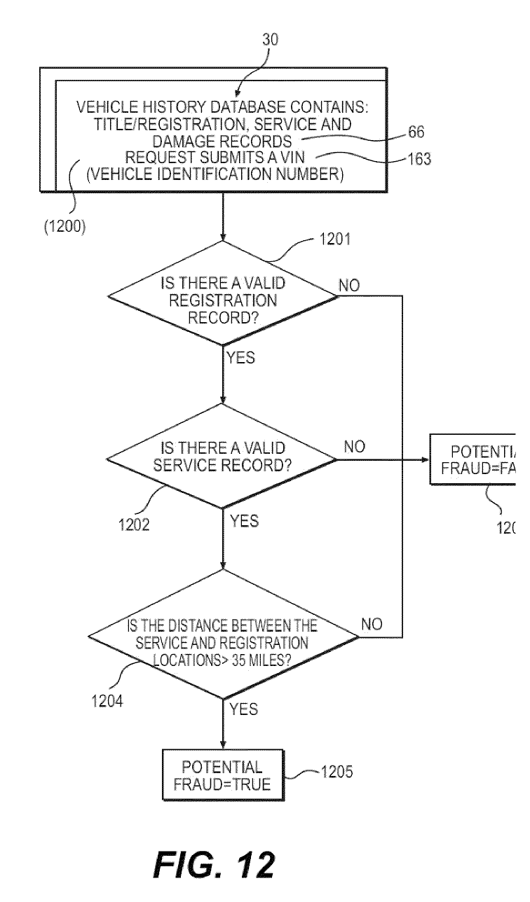

### FIG. 12

In FIG. 12, 1200, the background of the determining step 164 is that the vehicle history database 30 contains title/registration, service and damage data, and the request submits a VIN 163. The logic of the embodiments proceeds through a decision process, asking “Is there a valid registration record?” 1201. If no, then potential fraud=false 1203. However, if yes, then it is asked, “Is there a valid service record?” 1202. If no then potential fraud=false 1203. However, if yes, then it is asked “Is the distance between the service and the registration locations >35 miles?” 1204″. If no then potential fraud=false 1203. If yes then potential fraud=true 1205. This is based on the assumption a valid registration record is associated with the most recent owner, and contains a five digit zip code associated with a location. A valid service record is associated with the most recent owner, a service facility identified by the vehicle history provider, such as CARFAX™, and the distance calculation is performed by taking the service and registration zip codes, looking up the GPS coordinates associated with the zip codes and determining the mileage between the two zip codes. This resulting mileage is then compared to 35 miles to determine if the variable is true or false.

Thus, the determining step here comprises determining that there is a valid registration record and an indication that that there is a valid service record and the distance between the service and registration locations >35 miles leads to a flagging of potential fraud. If all three are true, i.e. yes, then the determining step determines that there is potential fraud.

### Example VI

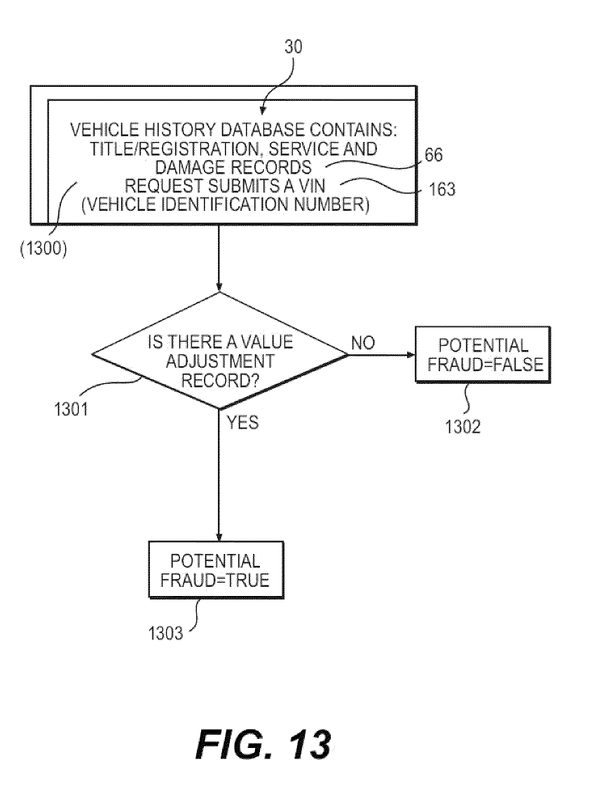

### FIG. 13

In FIG. 13, at 1300, the background of the determining step 164 is that the vehicle history database 30 contains title/registration, service and damage data, and the request submits a VIN 163. The logic of the embodiments proceeds through a decision process, asking “Is there a value adjustment record?” 1301. If no, then potential fraud=false 1302. However, if yes, then potential fraud=true 1303. This is based on the assumption that a valid value adjustment record is associated with the vehicle, not owner specific and is one of the following: Title Brand, Accident, Failed Inspection, Odometer Problem, or High Mileage related to the industry standard. A title brand occurs when a title is updated per state regulations indicating a damage condition. Accident is when the vehicle history provider (e.g., CARFAX™) has received information that an accident has occurred. Failed inspections means that a state safety or emission inspection has been performed and the vehicle has failed the inspection. With the odometer problem, the vehicle history provider has determined that an actual or potential problem exists with the odometer. High mileage means that the mileage on the vehicle in question exceeds normal mileage.

Thus, the determining step here comprises determining if there is a value adjustment record. If value adjustment is true, i.e. yes, then the determining step determines that there is potential fraud.

### Example VII

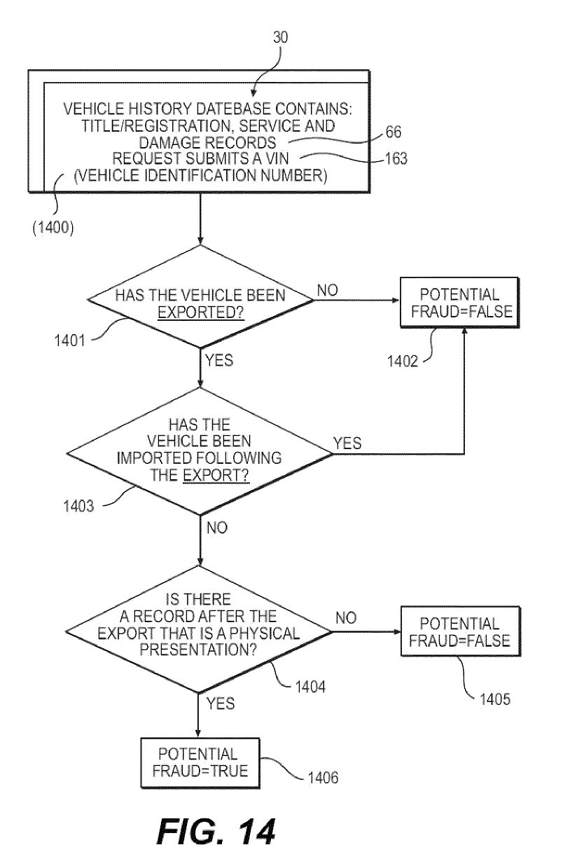

### FIG. 14

In FIG. 14, at 1400, the background of the determining step 164 is that the vehicle history database 30 contains title/registration, service and damage data, and the request submits a VIN 163. The logic of the embodiments proceeds through a decision process, asking “Has the vehicle been exported?” 1401. If no, then potential fraud=false 1402. However, if yes, then it is asked, “Has the vehicle been imported following the export?” 1403. If yes then potential fraud=false 1402. However, if no, then it is asked “Is there a record after the export that it is a physical presentation 1404”. If no then potential fraud=true 1405. If yes then potential fraud=false 1406. This is based on the definitions that exports are vehicles that have been sent outside the United States and imports are vehicles that have been brought into the United States. In this context, physically presented indicates that the vehicle history provider has received a recent record that the vehicle has been verified as a real vehicle by a reputable source.

Thus, the determining step here comprises determining if there is an indication that the vehicle has been exported and the vehicle has not been imported following the export and there is no record after the export that is a physical presentation. If exported is true and both physically presented and imported are false, then the determining step determines that there is potential fraud.

### Example VIII

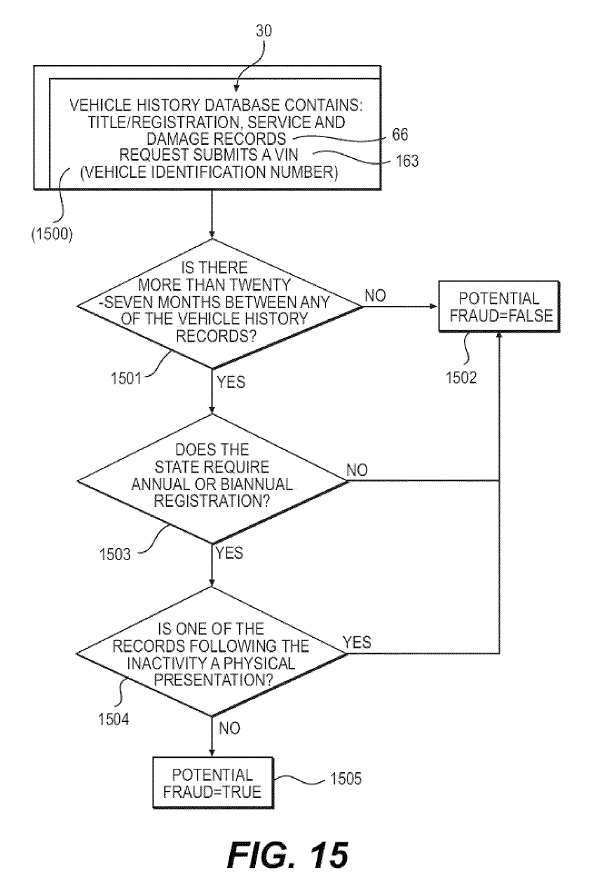

### FIG. 15

In FIG. 15, at 1500, the background of the determining step 164 is that the vehicle history database 30 contains title/registration, service and damage data, and the request submits a VIN 163. The logic of the embodiments proceeds through a decision process, asking “Is there more than twenty-seven months between any of the vehicle history records?” 1501. If no, then potential fraud=false 1502. However, if yes, then it is asked, “Does the state require annual or biannual registration?” 1503. If no then potential fraud=false 1502. However, if yes, then it is asked “Is one of the records following the inactivity a physical presentation? 1504”. If no then potential fraud=true 1505. If yes then potential fraud=false 1502. This is based on the definitions that physically presented indicates that the vehicle history provider ( ) has received a recent record that the vehicle has been verified as a real vehicle by a reputable source.

Thus, the determining step here comprises determining if there are a combination of an indication that there is more than twenty-seven months between any of the vehicle history records, an indication that the state requires annual or biannual registration, and an indication that none of the records following the inactivity is a physical presentation, thus leading? [leads] to a flagging of potential fraud. If both 27 months between records and annual/biannual registration are true, i.e. yes, and one of the subsequent records is not a physical presentation, i.e. no, then the determining step determines that there is potential fraud.

### Example IX

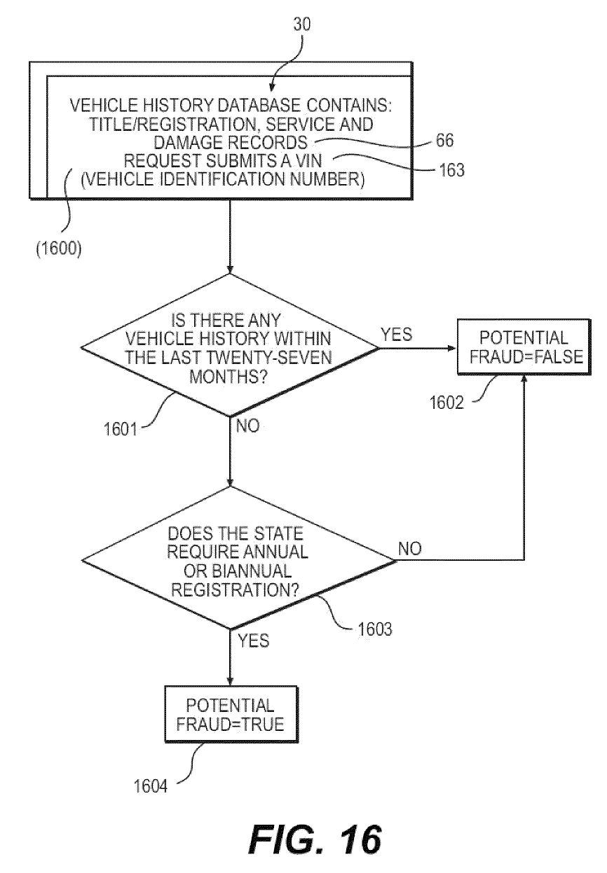

### FIG. 16

In FIG. 1600, the background of the determining step 164 is that the vehicle history database 30 contains title/registration, service and damage data, and the request submits a VIN# 163. The logic of the embodiments proceeds through a decision process, asking “Is there any vehicle history within the last twenty-seven months” 1601. If no, then potential fraud=false 1602. However, if yes, then it is asked, “Does the state require annual or biannual regulation?” 1603. If no, then potential fraud=false 1602. However, if yes, then potential fraud=true 1604.

Thus, the determining step here comprises determining that? if there are a combination of indications that there is not any vehicle history within the last twenty-seven months and the state requires annual or biannual registration, this? leads to a flagging of potential fraud. If there is no vehicle history within the last twenty-seven months, i.e. no, and annual or biannual registration is required, i.e. yes, then the determining step determines that there is potential fraud.

### Example X

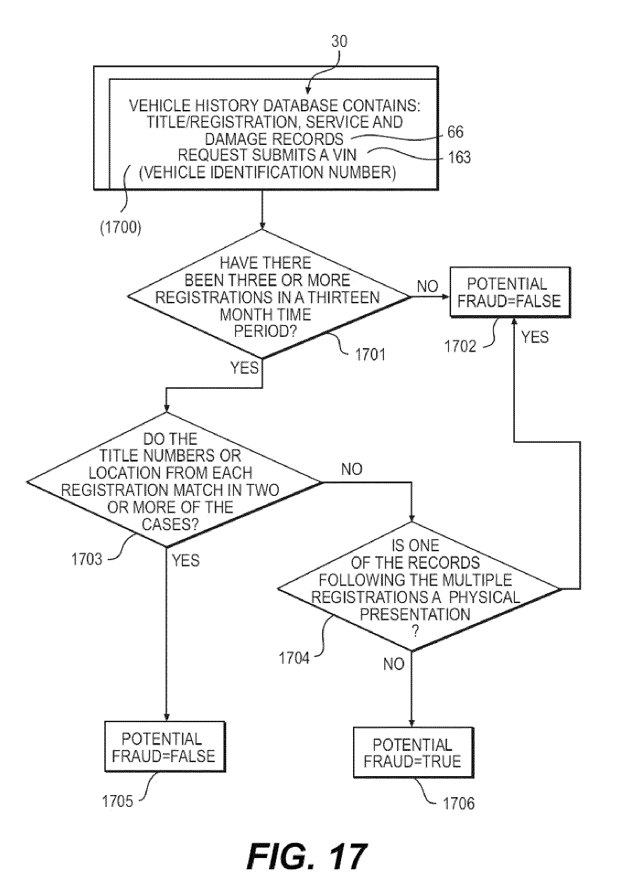

### FIG. 17

In FIG. 17, at 1700, the background of the determining step 164 is that the vehicle history database 30 contains title/registration, service and damage data, and the request submits a VIN 163. The logic of the embodiments proceeds through a decision process, asking “Have there been three or more registrations in a thirteen month period?” 1701. If no, then potential fraud=false 1702. However, if yes, then it is asked, “Do the title numbers or location from each registration match in two or more of the cases?” 1703. If yes, then potential fraud=false 1705. However, if no, then it is asked “Is one of the records following the multiple registrations a physical presentation? 1704. If no then potential fraud=true 1706. If yes then potential fraud=false 1702. In this context, physically presented indicates that the vehicle history provider has received a record that the vehicle has been verified as a real vehicle by a reputable source.

Thus, the determining step here comprises determining if, first, there is a combination of an indication that there have been three or more registrations in a thirteen month period, second, that the title numbers or location from each registration do not match in two or more of the cases, and finally that none of the records following the multiple registrations is a physical presentation will lead to a flagging of potential fraud. That is, if three or more registrations in a thirteen month period, i.e. yes, and no to both of the title number or location from each registration match in two or more of the cases (i.e. no), and one of the records following the multiple registrations is not a physical presentation, (i.e. no), then the determining step determines that there is potential fraud.

Thus the embodiments not only provide a method and system for predicting likelihood of fraud associated with a vehicle based on vehicle history, but also a method and system for generating information, i.e. overall value of one or more groups of variables, values of individual data variables, a score, etc, useful in assessing risk related to fraud for insurance policies. That is, the insurance company may receive the value of one or more variables, the overall value of one or more groups and/or a score or value, and then use that data to take action based on fraud likelihood information, such as described herein.

Any algorithm or rule can be applied to vehicle history data variables, individually or as a group, to determine values to be used for fraud likelihood analysis. The values can be expressed as scores, binary values, numeric or non numeric variables, or the like. The embodiments of the invention can be used for fraud likelihood prediction, insurance risk assessment, or both processes.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

We claim:

1. A computer-implemented method of inferring potential fraud related to a vehicle insurance transaction using an electronic vehicle history database, comprising the steps of:
identifying a vehicle by at least one of receiving an insurance claim on an insurance policy associated with the vehicle or receiving a request for an insurance quote on the vehicle;
obtaining a VIN for the identified vehicle;
using a computing device, retrieving vehicle history information about the vehicle associated with said VIN from an electronic vehicle history database;
using a computing device, determining if the vehicle history information indicates potential fraud based on factors which show a relationship between said vehicle history information and potential fraud incidents related to the claim or the quote request; and
based on the results of said determination, flagging said incidents of potential fraud for further action.

2. The method of claim 1, further comprising:
determining quantitatively whether fraud is likely to be associated with the vehicle or not based on said results of said determination.

3. The method of claim 2, wherein said factors are grouped into a plurality of data groupings according to a predetermined scheme.

4. The method of claim 3, wherein said method further comprises generating a score based upon an overall value of each of the plurality of data groupings and determining a likelihood of fraud based upon the score.

5. The method of claim 4, wherein said score is calculated based on a weighted combination of overall values of said plurality of data groupings.

6. The method of claim 5, wherein said score is the sum of weighted overall values of each of said plurality of data groupings represented as a mathematical equation.

7. The method of claim 3, wherein vehicle history data variables formed within a data grouping are similar.

8. The method of claim 3, wherein vehicle history data variables gathered within a data group are specified by a user.

9. The method of claim 1, wherein the at least one data grouping includes at least one of: a Value Adjustment Flags data grouping; a Rate Adjustment Flags grouping; a Rate Evasion Flags data grouping; a Potential Fraud Flags data grouping; a VIN Clone Flags data grouping.

10. The method of claim 1, wherein when flagging calls for further action, launching a fraud investigation into that vehicle's history.

11. The method of claim 1, further comprising in said determining step, refusing to insure the vehicle if fraud is indicated.

12. The method of claim 1, wherein if the vehicle was identified in response to an insurance claim, refusing to pay the claim in part or in full if fraud is indicated.

13. The method of claim 1, wherein the vehicle history variables include at least one of: Title Brand/Total Loss, Accident, Failed Inspection, Odometer Problem, High Mileage, Non-Personal Ownership Type, Out-of-area Service Territory, Stolen, Recently for Sale, High Mileage Lease, Inactive, Extended Period of Inactivity, Multiple Registrations, Exported, and Last Activity Date.

14. The method of claim 1, wherein said determining step comprises determining if there is an indication that a vehicle is leased and an indication that the vehicle is driven more than standard industry norms.

15. The method of claim 1, wherein said determining step comprises determining if there is an indication that a vehicle history report has been acquired within the last 90 days and an indication that the report was requested by a consumer or auto dealer.

16. The method of claim 1, wherein said determining step comprises determining if there is an indication that a vehicle was stolen and that it was not reported as recovered by an authoritative vehicle history source.

17. The method of claim 1, wherein said determining step comprises determining if there is an indication that there is a non-personal ownership record and the record is associated with the current owner.

18. The method of claim 1, wherein said determining step comprises determining if there is a valid registration record and an indication that there is a valid service record and the distance between the service and registration locations is greater than a specified number of miles.

19. The method of claim 1, wherein said determining step comprises determining if there is a value adjustment record.

20. The method of claim 1, wherein said determining step comprises determining if there is an indication that the vehicle has been exported and there is no record after the export that the vehicle has been imported.

21. The method of claim 1, wherein said determining step comprises determining if there are a combination of indications that there is more than twenty-seven months between any of the vehicle history records, that the state requires annual or biannual registration, and that none of the records following the inactivity is a physical presentation.

22. The method of claim 1, wherein said determining step comprises determining if there are a combination of indications that there is not any vehicle history within the last twenty-seven months and the state requires annual or biannual registration.

23. The method of claim 1, wherein said determining step comprises determining if there are a combination of indications that there have been three or more registrations in a thirteen month period, that the title numbers or location from each registration do not match in two or more of the cases, and none of the records following the multiple registrations is a physical presentation.

24. A computer system designed for inferring potential fraud related to a vehicle insurance transaction using an electronic vehicle history database, comprising:
means for identifying a vehicle by at least one of receiving an insurance claim on an insurance policy associated with the vehicle or receiving a request for an insurance quote on the vehicle;
means for obtaining a VIN for the identified vehicle;
means for retrieving vehicle history information about the vehicle associated with said VIN from an electronic vehicle history database;
means for determining if the vehicle history information indicates potential fraud based on factors which show a relationship between said vehicle history information and potential fraud incidents related to the claim or the quote request; and
means for flagging said incidents of potential fraud for further action based on the results of the determining means.

25. The system of claim 24, wherein said means for determining comprises means for determining quantitatively whether fraud is likely to be associated with the vehicle or not based on said results of said determination.

26. The system of claim 25, wherein said factors are grouped into a plurality of data groupings according to a predetermined scheme.

27. The system of claim 26, comprising means for generating a score based upon an overall value of each of the plurality of data groupings and determining a likelihood of fraud based upon the score.

28. The system of claim 27, wherein said score is calculated based on a weighted combination of overall values of said plurality of data groupings.

29. The system of claim 28, wherein said score is the sum of weighted overall values of each of said plurality of data groupings represented as a mathematical equation.

30. The system of claim 26, wherein vehicle history data variables formed within a data grouping are similar.

31. The system of claim 26, wherein vehicle history data variables gathered within a data group are specified by a user.

32. The system of claim 24, wherein the at least one data grouping includes at least one of: a Value Adjustment Flags data grouping; a Rate Adjustment Flags data grouping; a Rate Evasion Flags data grouping; a Potential Fraud Flags data grouping; a VIN Clone Flags data grouping.

33. The system of claim 24, wherein when flagging calls for further action, launching a fraud investigation into that vehicle's history.

34. The system of claim 24, further comprising in said determining step, refusing to insure the vehicle if fraud is indicated.

35. The system of claim 24, wherein if the vehicle was identified in response to an insurance claim, refusing to pay the claim in part or in full if fraud is indicated.

36. The system of claim 24, wherein the vehicle history variables include at least one of: Title Brand/Total Loss, Accident, Failed Inspection, Odometer Problem, High Mileage, Non-Personal Ownership Type, Out-of-area Service Territory, Stolen, Recently for Sale, High Mileage Lease, Inactive, Extended Period of Inactivity, Multiple Registrations, Exported, and Last Activity Date.

37. The system of claim 24, wherein said means for determining determines if there is an indication that a vehicle is leased and an indication that the vehicle is driven more than standard industry norms.

38. The system of claim 24, wherein said means for determining determines if there is an indication that a vehicle history report has been acquired within the last 90 days and an indication that the report was requested by a consumer or auto dealer.

39. The system of claim 24, wherein said means for determining determines if there is an indication that a vehicle was stolen, that it was not reported as recovered by an authoritative vehicle history source, and that the vehicle was not physically presented.

40. The system of claim 24, wherein said means for determining determines if there is an indication that there is a non-personal ownership record and the record is associated with the current owner.

41. The system of claim 24, wherein said means for determining determines that if there is a valid registration record and an indication that there is a valid service record and the distance between the service and registration locations >35 miles, this? leads to a flagging of potential fraud.

42. The system of claim 24, wherein said means for determining determines if there is a value adjustment record.

43. The system of claim 24, wherein said means for determining determines if there is an indication that the vehicle has been exported and there is no record after the export that the vehicle has been imported.

44. The system of claim 24, wherein said means for determining determines if there are a combination of indications that there is more than twenty-seven months between any of the vehicle history records, that the state requires annual or biannual registration, and that none of the records following the inactivity is a physical presentation leads to? a flagging of potential fraud.

45. The system of claim 24, wherein said means for determining determines if there are a combination of indications that there is not any vehicle history within the last twenty-seven months and the state requires annual or biannual registration leads to? a flagging of potential fraud.

46. The system of claim 24, wherein said means for determining determines if there are a combination of indications that there have been three or more registrations in a thirteen month period, that the title numbers or location from each registration do not match in two or more of the cases, and none of the records following the multiple registrations is a physical presentation leads to a flagging of potential fraud.

47. A set of instructions encoded on a computer-readable medium, which when executed by a computer carries out a computer-implemented method of inferring potential fraud related to a vehicle insurance transaction using an electronic vehicle history database, said instructions comprising:
instructions for identifying a vehicle by at least one of receiving an insurance claim on an insurance policy associated with the vehicle or receiving a request for an insurance quote on the vehicle;
instructions for obtaining a VIN for the identified vehicle;
instructions for using a computing device, retrieving vehicle history information about the vehicle associated with said VIN from an electronic vehicle history database;
instructions for using a computing device, determining if the vehicle history information indicates potential fraud based on factors which show a relationship between said vehicle history information and potential fraud incidents related to the claim or the quote request; and
instructions for, based on the results of said determination, flagging said incidents of potential fraud for further action.

48. The instructions of claim 47, further comprising:
instructions for determining quantitatively whether fraud is likely to be associated with the vehicle or not based on said results of said determination.

49. The instructions of claim 48, wherein said factors are grouped into a plurality of data groupings according to a predetermined scheme.

50. The instructions of claim 49, wherein said instructions further comprise instructions for generating a score based upon an overall value of each of the plurality of data groupings and determining a likelihood of fraud based upon the score.

51. The instructions of claim 50, wherein said score is calculated based on a weighted combination of overall values of said plurality of data groupings.

52. The instructions of claim 51, wherein said score is the sum of weighted overall values of each of said plurality of data groupings represented as a mathematical equation.

53. The instructions of claim 49, wherein vehicle history data variables formed within a data grouping are similar.

54. The instructions of claim 49, wherein vehicle history data variables gathered within a data group are specified by a user.

55. The instructions of claim 47, wherein the at least one data grouping includes at least one of: a Value Adjustment Flags data grouping; a Rate Adjustment Flags data grouping; a Rate Evasion Flags data grouping; a Potential Fraud Flags data grouping; a VIN Clone Flags data grouping.

56. The instructions of claim 47, wherein when flagging calls for further action, launching a fraud investigation into that vehicle's history.

57. The instructions of claim 47, further comprising in said determining step, refusing to insure the vehicle if fraud is indicated.

58. The instructions of claim 47, wherein if the vehicle was identified in response to a request for an insurance claim, refusing to pay the claim in part or in full if fraud is indicated.

59. The instructions of claim 47, wherein the vehicle history variables include at least one of: Title Brand/Total Loss, Accident, Failed Inspection, Odometer Problem, High Mileage, Non-Personal Ownership Type, Out-of-area Service Territory, Stolen, Recently for Sale, High Mileage Lease, Inactive, Extended Period of Inactivity, Multiple Registrations, Exported, and Last Activity Date.

60. The instructions of claim 47, wherein said instructions for determining comprise instructions for determining if there is an indication that a vehicle is leased and an indication that the vehicle is driven more than standard industry norms.

61. The instructions of claim 47, wherein said instructions for determining comprise instructions for determining if there is an indication that a vehicle history report has been acquired within the last 90 days and an indication that the report was requested by a consumer or auto dealer.

62. The instructions of claim 47, wherein said instructions for determining comprise instructions for determining if there is an indication that a vehicle was stolen, that it was not reported as recovered by an authoritative vehicle history source, and that the vehicle was not physically presented.

63. The instructions of claim 47, wherein said instructions for determining comprise instructions for determining if there is an indication that there is a non-personal ownership record and the record is associated with the current owner.

64. The instructions of claim 47, wherein said instructions for determining comprise instructions for determining if there is a valid registration record and an indication that there is a valid service record and the distance between the service and registration locations >35 miles, leading? leads to a flagging of potential fraud.

65. The instructions of claim 47, wherein said instructions for determining comprise instructions for determining if there is a value adjustment record.

66. The instructions of claim 47, wherein said instructions for determining comprise instructions for determining if there is an indication that the vehicle has been exported and there is no record after the export that the vehicle has been imported.

67. The instructions of claim 47, wherein said instructions for determining comprise instructions for determining if there are a combination of indications that there is more than twenty-seven months between any of the vehicle history records, an indication that the state requires annual or biannual registration, and an indication that none of the records following the inactivity is a physical presentation, leading? leads to a flagging of potential fraud.

68. The instructions of claim 47, wherein said instructions for determining comprise instructions for determining if there are a combination of indications that there is not any vehicle history within the last twenty-seven months and the state requires annual or biannual registration leads to a flagging of potential fraud.

69. The instructions of claim 47, wherein said instructions for determining comprise instructions for determining if there are a combination of indications that there have been three or more registrations in a thirteen month period, that the title numbers or location from each registration do not match in two or more of the cases, and none of the records following the multiple registrations is a physical presentation leads to a flagging of potential fraud.
